(19) United States
(12) Patent Application Publication
(10) Pub. No.: US 2024/0277580 A1
(43) Pub. Date: Aug. 22, 2024

(54) INFANT BOTTLE

(71) Applicant: Jennifer Russ, Ashgrove (AU)

(72) Inventor: Jennifer Russ, Ashgrove (AU)

(21) Appl. No.: 18/570,785

(22) PCT Filed: Jun. 15, 2022
(86) PCT No.: PCT/AU2022/050588

§ 371 Date: Dec. 15, 2023

(30) Foreign Application Priority Data
Jun. 15, 2021 (AU) 2021901790

(51) Int. Cl. A61J 11/00; A47J 36/28; B01F 27/91; B01F 101/00

(52) U.S. Cl. CPC A61J 11/0095; A47J 36/28; B01F 27/91; B01F 2101/2204

(57) ABSTRACT

Kindly amend the Abstract, wherein underlining indicates additions and strikethrough indicates deletion, as follows:

An infant feeding bottle is provided that is convenient and easy to use. The bottle can include a formula reservoir, comprising sealed and sterilised formula for consumption by an infant; a teat, through which the formula from the formula reservoir may be consumed; and an exothermic self-heating element, configured to heat the formula in the formula reservoir upon activation thereof. The exothermic self-heating element includes one or more mixing elements, configured to assist in mixing elements of an exothermic reaction of the exothermic self-heating element.

### CROSS-REFERENCE TO RELATED APPLICATION

This application is a U.S. National Phase of International Patent Application No. PCT/AU2022/050588, filed Jun. 15, 2022, which, claims priority to and the benefit of Australian Patent Application Number 2021901790, filed on Jun. 15, 2021, for which the disclosures of each are incorporated herein by reference in their entirety.

### TECHNICAL FIELD

The present invention relates to infant feeding bottles. In particular, although not exclusively, the present invention relates to pre-filled infant feeding bottles for use outside of the home.

### BACKGROUND ART

Infant bottles have long been used to feed formula to infants as an alternative to breast milk. Infant formula is typically provided as a powder, which is mixed with boiled water to form a drinkable liquid.

When outside of the home, it is often not easy to accurately measure formula and water, mix the formula and water without spilling, while ensuring sterility and appropriate temperature. As such, formula is often pre-mixed and cooled, and carried until needed, where it may be heated, if desired.

One problem with carrying pre-mixed formula is that it is heavy, as one is not only carrying the powdered formula, but also the water. This is particularly problematic given that many other items are often carried when outside of the home with infants.

Another problem with carrying pre-mixed formula is that it can become warm, and potentially breed bacteria, which can become a health risk for the infant. As such, insulated carriers are often used, particularly in warm environments, which adds to the load being carried.

Yet another problem with carrying pre-mixed formula is that many infants do not like to drink formula cold, and heating equipment may not be readily available. Even when microwaves or boiling water is available, it is not necessarily safe or practical to use to heat formula.

Certain portable bottle heaters exist, which enable bottles to be heated when out and about. A problem with such heaters is that they require some form of power, such as mains power or batteries, and are thus either inconvenient or heavy, and are also costly.

Certain exothermic heating elements exist, that utilise a chemical reaction to heat food or drink. A problem with such exothermic heating elements in the context of infant bottles is that there is great variation in the reaction of the elements, and thus resultant temperature. While beverages, such as coffee, can have high levels of heat variation (e.g. a temperature variation of 55-85 C may be acceptable, i.e. 30 C), in infant formula a 30 C difference in formula temperature could be dangerous for an infant.

Another problem again with carrying pre-mixed formula is that it requires time and planning. When unexpectedly needing to go out with an infant, it may not be possible to prepare pre-mixed formula and cool it to an appropriate temperature before leaving. Furthermore, pre-prepared infant formula has a low shelf life, and as such, it is not feasible to pre-prepare bottles of formula when not planning on actually using it.

As such, there is clearly a need for an improved infant bottle.

It will be clearly understood that, if a prior art publication is referred to herein, this reference does not constitute an admission that the publication forms part of the common general knowledge in the art in Australia or in any other country.

### SUMMARY OF INVENTION

The present invention relates to infant feeding bottles, which may at least partially overcome at least one of the abovementioned disadvantages or provide the consumer with a useful or commercial choice.

With the foregoing in view, the present invention in one form, resides broadly in an infant feeding bottle comprising:
a formula reservoir, comprising sealed and sterilised formula for consumption by an infant;
a teat, through which the formula from the formula reservoir may be consumed; and
an exothermic self-heating element, configured to heat the formula in the formula reservoir upon activation thereof, wherein the exothermic self-heating element includes one or more mixing elements, configured to assist in mixing elements of an exothermic reaction of the exothermic self-heating element.

Advantageously, the infant feeding bottle is convenient, as it may be purchased and used on the run or as needed, without requiring any external power or equipment, such as a microwave, hot water, or any other external heating, and without requiring any measuring or mixing, in contrast to using powdered formulas. Furthermore, as the formula is sealed and sterilised, it may be stored at room temperature for significant periods of time without perishing.

Preferably, the infant feeding bottle comprises a single-use bottle. This enables the bottle to be used when needed, and discarded or recycled.

Preferably, the exothermic self-heating element is non-toxic.

The self-heating element may be configured to heat based upon an exothermic reaction between two or more components of the self-heating element. The two or more components may be separated by a seal. The seal may be configured to be broken to activate the self-heating element.

The self-heating element may include calcium oxide and water, configured to react with each other to generate heat.

Alternatively, the self-heating element may be configured to heat based upon an exothermic reaction with one or more components of the self-heating element and air. The self-heating element may include one or more removable tabs to expose the one or more components to air.

The self-heating element may include one or more apertures which are sealed by the one or more removable tabs.

The self-heating element may include powdered iron, configured to react with oxygen from the air to generate heat. The heating element may include salt to catalyse the reaction.

The one or more mixing elements may comprise passive mixing elements.

The passive mixing elements may comprise granular material to improve permeation of elements of the exothermic reaction with each other.

The granular material may be around 1 mm in size. The granular material may be about 2 mm in size.

The granular material may comprise glass beads, plastic beads and rice. The granular material may be porous.

The passive mixing elements may comprise a matrix to improve permeation of elements of the exothermic reaction with each other.

The mixing elements may comprise an active mixing element.

The active mixing element may comprise a mixer, configured to rotate upon interaction with a user. The mixer may be configured to rotate when another element of the bottle, such as a base of the bottle, is rotated.

The active mixing element may be further configured to pierce a seal between two or more components of the self-heating element to initiate the exothermic reaction.

The self-heating element may be removable from the bottle.

The self-heating element may be integrally formed with the bottle. At least part of an internal wall of the formula reservoir may comprise a wall of the self-heating element.

An internal sidewall of the formula reservoir may comprise a wall of the self-heating element.

The self-heating element may include a central heating portion, extending into the reservoir, to heat the formula therein from an inside of the reservoir.

The bottle may comprise a planar base, from which a sidewall upwardly extends. The bottle may be circular in cross section.

The bottle may include a removable cap configured to cover the teat. This may prevent the teat from becoming unclean during transport, storage and handling. The cap may be a tamper resistant cap.

The bottle may include a thermal indicator, indicating when the bottle is at a desired temperature. The thermal indicator may comprise a thermometer. The thermal indicator may comprise colour changing indicia, such as words.

The bottle may be formed substantially entirely of plastic.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates an upper perspective view of a pre-filled infant feeding bottle, according to an embodiment of the present invention.

FIG. 2 illustrates a front view of the pre-filled infant feeding bottle of FIG. 1.

FIG. 3 illustrates a rear view of the pre-filled infant feeding bottle of FIG. 1.

FIG. 4 illustrates a top view of the pre-filled infant feeding bottle of FIG. 1.

FIG. 5 illustrates a bottom view of the pre-filled infant feeding bottle of FIG. 1.

FIG. 6a illustrates a cross-sectional view of the pre-filled infant feeding bottle of FIG. 1 prior to the base being rotated (i.e. in the default position).

FIG. 6b illustrates a cross-sectional view of the pre-filled infant feeding bottle of FIG. 1 after the base has been rotated (in the activated position), where the water and calcium oxide are mixing for the exothermic reaction.

FIG. 7a illustrates a cut-away perspective view of the pre-filled infant feeding bottle of FIG. 1, prior to the base being rotated (i.e. in the default position).

FIG. 7b illustrates a cut-away view of the pre-filled infant feeding bottle of FIG. 1 after the base has been rotated (in the activated position).

FIG. 8 illustrates a perspective view of a mixer, which can be used to actively mix the water and calcium oxide powder in a bottle such as the bottle of FIG. 1, according to an embodiment of the present invention.

FIG. 9 illustrates a side view of a chamber, similar to the combined chambers of the bottle of FIG. 1, including the mixer of FIG. 8.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

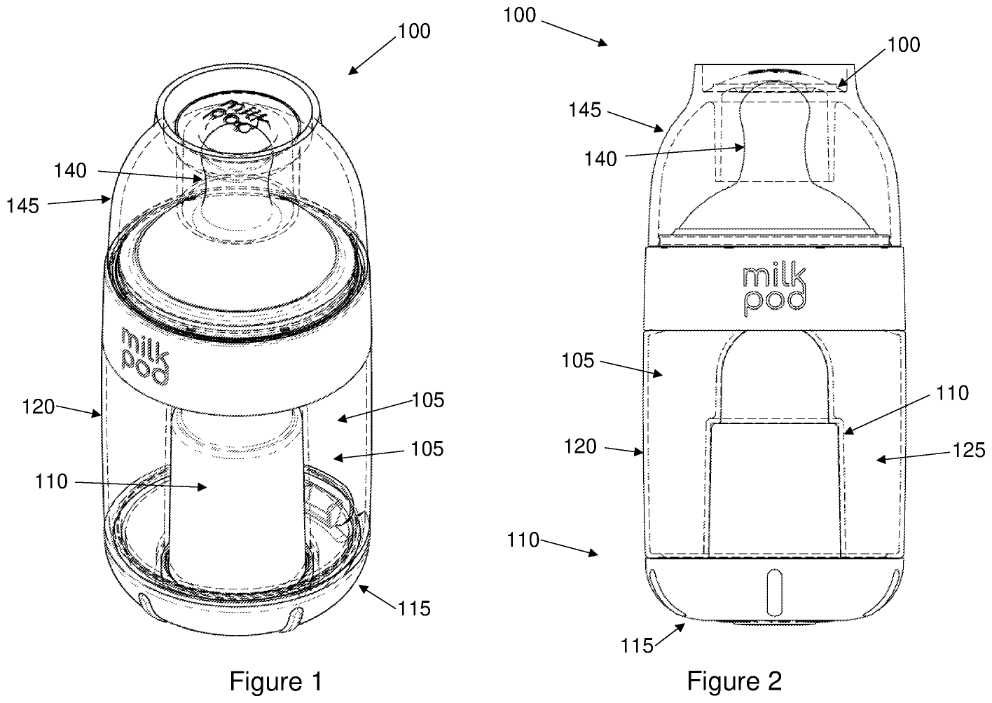

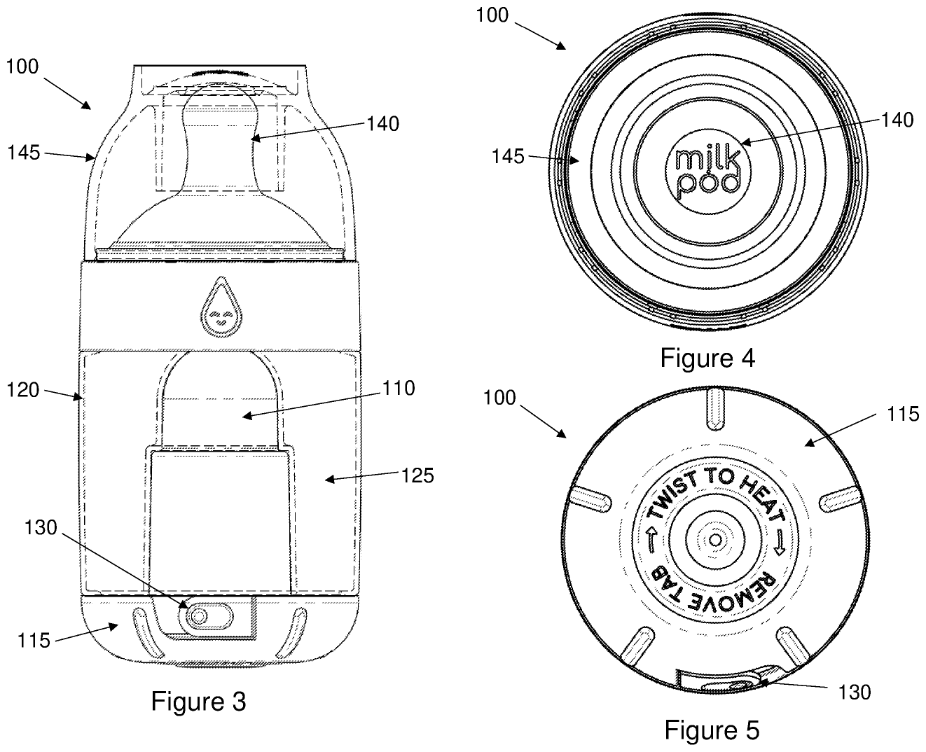

FIG. 1 illustrates an upper perspective view of a pre-filled infant feeding bottle 100, according to an embodiment of the present invention. FIG. 2 illustrates a front view of the pre-filled infant feeding bottle 100, FIG. 3 illustrates a rear view, FIG. 4 illustrates a top view and FIG. 5 illustrates a bottom view of the pre-filled infant feeding bottle 100.

The infant feeding bottle 100 is ready to use, and is thus particularly suited to being purchased when needed, but may be pre-purchased and packed for use on a journey.

The infant feeding bottle 100 is pre-filled with pasteurised/sterilised and ready-to-drink formula 105, and includes a self-heating element 110, which enables the formula 105 therein to be heated to a suitable temperature without requiring any external power or equipment, such as a microwave, hot water, or any other external heating. In this context, suitable temperatures may vary, but are often at around 37-39° C., and typically above about 20° C.

The pre-filled infant feeding bottle 100 is illustrated with clear plastic, and with clear ready-to-drink formula 105, thus simplifying the process of showing an inside of the pre-filled infant feeding bottle 100, for the sake of clarity. The skilled addressee will, however, readily appreciate that such formula 105 is generally opaque, and the components of the bottle 100 need not be transparent.

The infant feeding bottle 100 comprises a base 115, from which a sidewall 120 upwardly extends, and thus has the appearance of a traditional infant bottle reservoir. A reservoir 125, which is filled with the ready-to-drink formula 105, is defined by the base 115, sidewall 120 and the self-heating element 110.

The self-heating element 110 is located on an inside of the reservoir 125. In particular, walls of the self-heating element 110 form inner walls of the reservoir 125, and thus are in direct contact with the formula 105.

The self-heating element 110 comprises water and calcium oxide, which are configured to react to form calcium hydroxide and generate heat in an exothermic reaction, as outlined in further detail below. In other embodiments, however, other types of exothermic reactions may take place, including powdered iron configured to react with oxygen from the air to form iron oxide.

As the self-heating element 110 is in direct contact with the formula 105, it thereby heats the formula 105.

The base 115 is configured to rotate relative to the reservoir 125, and cause a seal between water and calcium oxide therein to be broken, thereby initiating the exothermic reaction. A removable tab 130 is provided to prevent accidental rotation of the base 115, such that in use, the tab 130 is first removed and the base is then rotated.

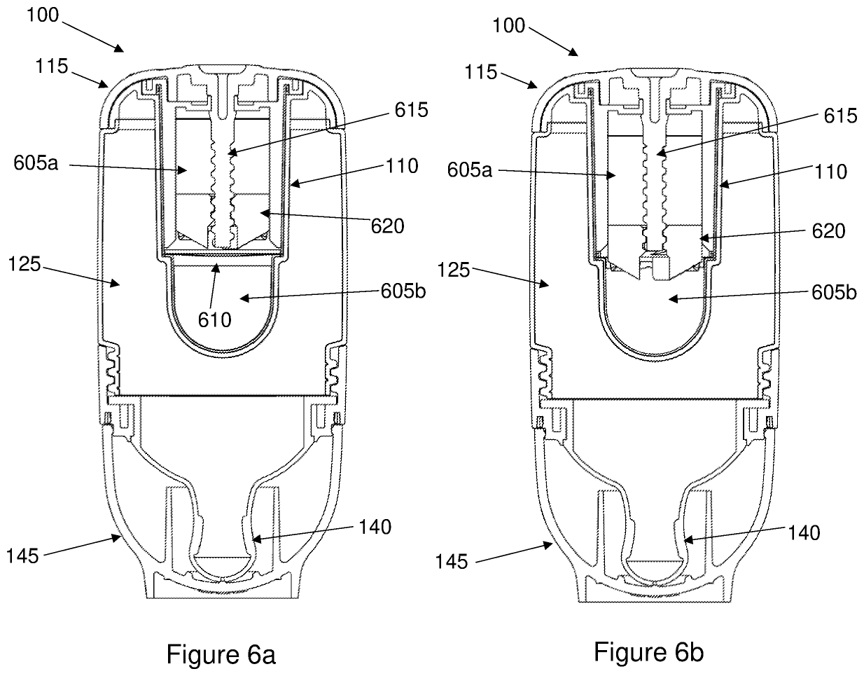

FIG. 6a illustrates a cross-sectional view of the bottle 100 prior to the base being rotated (i.e. in the default position), and FIG. 6b illustrates a cross-sectional view of the bottle 100 after the base has been rotated (in the activated position), where the water and calcium oxide are mixing for the exothermic reaction.

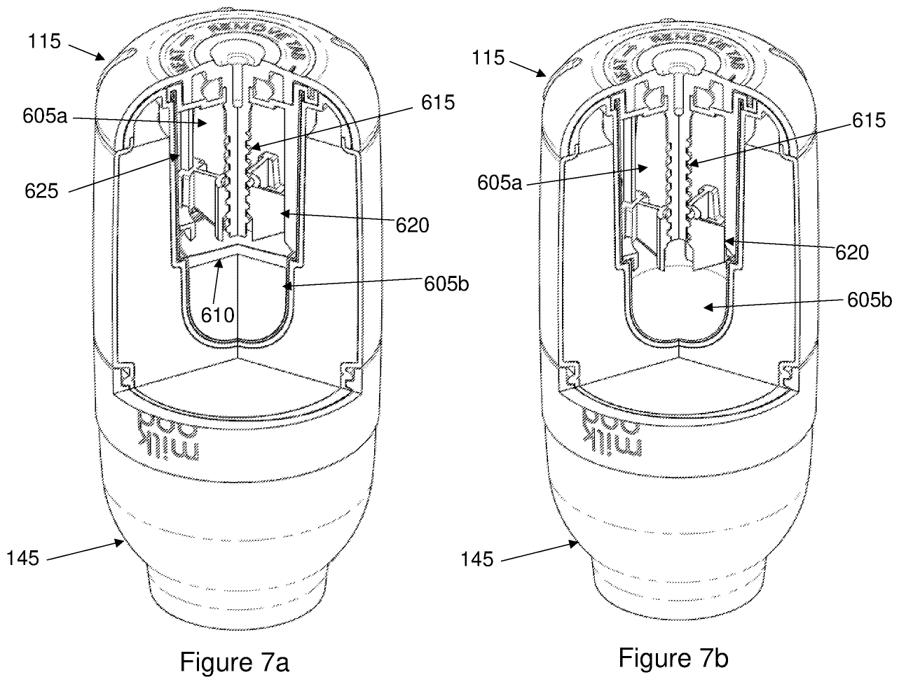

Similarly, FIG. 7a illustrates a cut-away perspective view of the bottle 100 prior to the base being rotated (i.e. in the default position), and FIG. 7b illustrates a cut-away view of the bottle 100 after the base has been rotated (in the activated position).

The self-heating element 110 comprises first and second sealed chambers 605a, 605b, containing the water and calcium oxide respectively. A seal 610 is provided between and separating the first and second sealed chambers 605a, 605b.

A threaded shaft 615 extends from the base 115, such that the threaded shaft rotates when the base 115 is rotated. The threaded shaft 615 extends into the first sealed chamber 605a, where it engages with a piercing member 620.

Upon rotation of the base 115, and thus threaded shaft 615, the piercing member 620 is forced towards the seal 610. The piercing member 620 includes sharp edges configured to pierce through the seal 610, and thereby enable the water and calcium oxide to mix.

As best illustrated in FIGS. 7a, 7b, the piercing member 610 engages with internal guides 625 extending down a length of the first chamber 605a to prevent rotation of the piercing member 620 and force lateral movement of the piercing member 610 from the rotation of the base 115.

Finally, and turning back to FIGS. 1-3, the infant feeding bottle includes a teat 140, and a removable cap 145 covering the teat 140. The teat 140 is for consuming the formula, and the removable cap 145 prevents the teat 140 from becoming unclean during transport, storage and handling. The cap 145 may be a tamper resistant cap. The tamper resistant cap may ensure cleanliness of the teat 140 all the way from manufacture to consumption by the infant. The cap 145 may include a frangible base, enabling it to be broken from the bottle 100, thereby being single use.

The second sealed chamber 605b, in addition to containing calcium oxide, may contain elements to assist in mixing of the water and calcium dioxide. As outlined above, inconsistent mixing of the elements of the exothermic reaction can create significant differences in final temperature, which is particularly problematic with infant formula, where large temperature differences can either result in a dangerous situation, or be unpalatable.

In one embodiment, granular materials are added to the calcium oxide to assist in the permeation of water into the calcium oxide powder. Examples of granular material include glass beads, plastic beads and rice (dry). The granular material may be around 1 mm in diameter. The granular material may be about 2 mm in size.

The granular material may be porous to further promote the flow of water through the calcium oxide powder.

In another embodiment, a matrix is introduced into the calcium oxide powder to promote the flow of water through the calcium oxide powder. The matrix may be formed of any suitable material and shape, including stainless steel wool mixed with powdered calcium oxide, and 3D printed structures. Any suitable 3D printed shape may be used, including a geodesic sphere.

In some embodiments, the calcium oxide powder is suspended in a water-permeable bag in the chamber 605b. Such configuration may enable the water to immediately react with the calcium oxide powder from all sides (i.e. not just from above).

Similarly, surfactant may be added to the water to reduce surface tension and promote mixing of water and the calcium oxide powder.

In other embodiments, the water and calcium oxide powder are actively mixed. In such case, a mechanical mixer may extend into the chamber 605b to actively mix the water and calcium oxide powder.

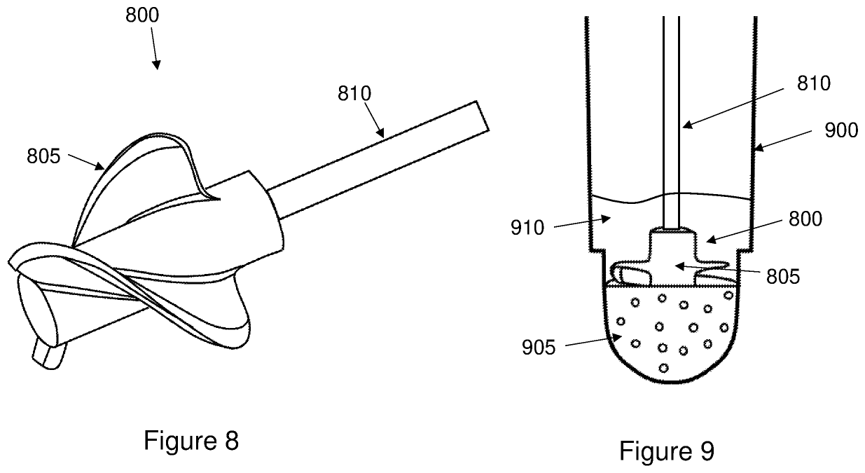

FIG. 8 illustrates a perspective view of a mixer 800, which can be used to actively mix the water and calcium oxide powder. FIG. 9 illustrates a side view of a chamber 900, similar to the combined chambers 605a, 605b, including the mixer 800.

The mixer comprises a mixer head 805, including a plurality of fins, that are arranged to lift the water and calcium oxide powder during mixing, much like a turbine or propeller.

A shaft 810 extends from the mixer head 805, such that axial rotation of the shaft 810 causes rotation of the mixer head 805, and thus mixing of the water and calcium oxide powder.

As best illustrated in FIG. 9, once the seal between the water and calcium oxide powder is broken, calcium oxide powder 905 is initially at the bottom of the chamber 900, with water 910 directly thereabove.

The mixer 800 is rotated, which lifts the calcium oxide powder 905 into the water 910, and causes the water to fall into voids defined by the lifting of the calcium oxide powder 905. After a small number of rotations (e.g. 3), the calcium oxide powder 905 and the water 910 is sufficiently mixed to provide a consistent reaction (i.e. without significant variability).

The mixer 800 may replace the piercing member 620 in the bottle 100, and may function to both pierce the seal 610 and mix the water 910 and powder 905. In such case, the mixer may be coupled to the shaft 615 so that the mixer first lowers through the seal 610 (and piercing same), and then rotates with the shaft 620, when the base 115 is rotated.

In other embodiments, a piercing member and a mixing member may be separately provided.

In some embodiments, the mixer 800 is geared, such that a relatively small rotation of the base 115 corresponds to a much greater rotation of the mixer 800. As an illustrative example, partial rotation of the base 115 may correspond to three full rotations of the mixer 800.

The above examples prevent, or at least reduce the likelihood of a barrier forming at a boundary of the water and calcium oxide powder, thereby delaying (or preventing) part of the reaction. The skilled addressee will readily appreciate that similar teachings may be applied to other exothermic reactions, without deviating from the scope of the invention.

In other embodiments, particularly where the heating element is configured to react with oxygen in the atmosphere, the bottom of the infant feeding bottle may include a pull tab in the form of a removable sticker, which seals the self-heating element, rather than a twist-base 115. The pull tab may be removed to allow air to reach the self-heating element and thereby initiate the exothermic reaction.

Such configuration may be useful in that much of the energy is transferred to the formula 105 from the bottom (and heat rises), and given that the apertures are formed in the planar base 115, the oxygen from the air does not need to travel far for the majority of the reaction.

In such case, removal of the pull tab may expose a plurality of apertures, which thereby allow air to reach the powdered iron (or other element) of the self-heating element to thereby initiate the exothermic reaction. The heating element may include salt to catalyse the reaction.

The self-heating element 110 in the figures described above is shaped such it is located entirely on an inside of the reservoir 125. In other embodiments, however, the self-heating elements may have different shapes. In one embodiment, the self-heating element may be located primarily at the base of the reservoir. In another embodiment, the self-heating element may be defined in the outer walls of the reservoir, thereby heating the formula 105 from the outside.

By extending the self-heating element 110 up the sidewalls 120 may be beneficial in providing more even heating, and avoiding hot and cold spots in the formula 105. This is particularly relevant as the bottle 100 is shaken, as formula 105 will be in contact with all sides of the self-heating element 110.

In some embodiments, the self-heating element may be at least partly removable from the bottle 100. This is particularly useful when the formula has already reached a desired temperature to avoid overheating.

In such case, the self-heating element 110 may comprise a module coupled to the base, such that the base (or part of the base) may be removed, leaving a partly hollow reservoir 125.

The cap 145 may be configured to engage with top of self-heating element 110, not only to support the gap 145, but potentially to shield the self-heating element 110.

The formula 105, unlike powdered formula to be mixed, often using inaccurate equipment, may be prepared to high standards and in a controlled environment. Unlike powdered formula, which is dried and reconstituted, the formula 105 may be made from fresh ingredients, and may include oils or emulsions that are not easily included in powdered formula.

The heating element 110 is single use, and the bottle 100 is single-use (disposable). Preferably, the bottle 100 is formed of recyclable or biodegradable plastics or other materials making it environmentally friendly, e.g. when compared with general plastics. The self-heating element 110 may be separated from the plastic (or other material) for recycling, and is advantageously non-toxic and environmentally friendly.

The bottle 100 may be primarily formed of impact resistant material, such as polypropylene or another suitable material, to prevent both the damage to the bottle 100, separation of the self-heating element 110 from the bottle 100, or damage of the interface between the self-heating element 110 and the reservoir 125, resulting in contamination of the formula.

The skilled addressee will readily understand that the arrangement of the self-heating element 110 illustrated in the bottle 100 is exemplary, and any other suitable form may be taken, including a self-heating element at the base, a self-heating element forming a sleeve around the bottle, and/or a self-heating element extending up into the reservoir.

While not illustrated, the bottles described above may include a thermal indicator or thermometer integrated therein, or applied to a surface thereof. In one embodiment, the thermal indicator may comprise a colour changing sticker or print on the bottle, which changes colour depending on the temperature of the formula. Such colour change can include making text visible at certain temperatures, such as the words “too cool”, when the formula is too cold, “perfect” or “ready” when the formula is the right temperature, and “too hot” or “warning” when the formula is too hot. The words may also be coloured, e.g. blue when too cold, green when the right temperature, and red when too hot.

The bottles described above are illustrated in a single size. The skilled addressee will readily appreciate that different sizes and formulations may be used to cater for different aged infants. As an illustrative example, a smaller baby bottle and a larger toddler bottle may be provided, each with age-appropriate formula. In such case, both the reservoir (formula) size and teat size, flow rate and shape may vary. Similarly, specialised versions of teats and/or bottles may be provided for infants with different requirements.

The skilled addressee will readily appreciate that instructions for drink preparation may be provided on the packaging. In most cases, however, the inventor envisages the preparation to be very simple, ideally simply activating the self-heating element, shaking the bottle, and waiting for the temperature to reach the appropriate level.

The self-heating elements of the bottles may be arranged such that they are not able to heat the formula to a temperature that may cause burns. This may be performed by ensuring that the self-heating elements heat at a controlled rate, and/or to a controlled level. The skilled addressee will readily appreciate that it is important that a bottle heats quickly, but also important that it doesn't continue to heat above a suitable temperature.

Furthermore, the outsides of the bottles may be insulated, so that the heat from the self-heating element is used to heat the formula, rather than dissipating into the atmosphere. In one embodiment, the sidewalls and base may include heat reflective or insulating material, which also ensures that heat from the self-heating element is directed primarily to the formula.

Advantageously, the infant feeding bottles disclosed herein are convenient, as they may be purchased and used on the run or as needed, without requiring any external power or equipment, such as a microwave, hot water, or any other external heating, and without requiring any measuring or mixing, in contrast to powdered formulas. Furthermore, as the formula is sealed and sterilised, it may be stored at room temperature for significant periods of time without perishing.

As there is no measuring or mixing, the meal is prepared to manufacturers standards, alleviating variation based on inaccuracies in measurements.

The use of a self-heating element which may control heat output, together with a thermal indicator or thermometer, reduces the risk of overheating the formula and associated burns. The thermal indicator is also useful in ensuring that formula is not provided that is too cold and thereby unpalatable to the infant.

While particularly suited for convenience when out and about, the products can also be used in any suitable situation. As an illustrative example, such pre-filled bottles may be provided in hospitals, day care centres or other environments, to ensure safe and accurate formula, while simplifying heating thereof.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An infant feeding bottle comprising:
a formula reservoir, comprising sealed and sterilised formula for consumption by an infant;
a teat, through which the formula from the formula reservoir may be consumed; and
an exothermic self-heating element, configured to heat the formula in the formula reservoir upon activation thereof,
wherein the exothermic self-heating element includes one or more mixing elements, configured to assist in mixing elements of an exothermic reaction of the exothermic self-heating element to improve permeation of elements.

2. The infant feeding bottle of claim 1, comprising a single-use bottle.

3. The infant feeding bottle of claim 1, wherein the self-heating element is configured to heat based upon an exothermic reaction between two or more components of the self-heating element.

4. The infant feeding bottle of claim 3, wherein the two or more components are separated by a seal.

5. The infant feeding bottle of claim 4, wherein the seal is configured to be broken to activate the self-heating element.

6. The infant feeding bottle of claim 1, wherein the self-heating element includes calcium oxide and water, configured to react with each other to generate heat.

7. The infant feeding bottle of claim 1, wherein the one or more mixing elements comprise passive mixing elements.

8. The infant feeding bottle of claim 7, wherein the passive mixing elements comprise one or more of granular material and a matrix to improve permeation of elements of the exothermic reaction with each other.

9. The infant feeding bottle of claim 1, wherein the mixing elements comprise active mixing elements.

10. The infant feeding bottle of claim 9, wherein the active mixing element comprises a mixer, configured to rotate upon interaction with a user.

11. The infant feeding bottle of claim 9, wherein the active mixing element is further configured to pierce a seal between two or more components of the self-heating element to initiate the exothermic reaction.

12. The infant feeding bottle of claim 1, wherein the self-heating element is removable from the bottle.

13. The infant feeding bottle of claim 1, wherein a sidewall of the formula reservoir comprises a wall of the self-heating element.

14. The infant feeding bottle of claim 1, wherein the self-heating element includes a central heating portion, extending into the reservoir, to heat the formula therein from an inside of the reservoir.

15. The infant feeding bottle of claim 1, wherein the bottle comprises a base, from which a sidewall upwardly extends.

16. The infant feeding bottle of claim 1, wherein the bottle is circular in cross section.

17. The infant feeding bottle of claim 1, including a removable cap configured to cover the teat.

18. The infant feeding bottle of claim 1, including a thermal indicator, indicating when the bottle is at a desired temperature.

19. The infant feeding bottle of claim 18. wherein the thermal indicator comprises colour changing indicia.

20. The infant feeding bottle of claim 1, wherein the exothermic self-heating clement is non-toxic.
